(19) United States
(12) Patent Application Publication
(10) Pub. No.: US 2015/0103773 A1
(43) Pub. Date: Apr. 16, 2015

(54) Communication Method and Apparatus

(71) Applicants: Klaus Ingemann Pedersen, Aalborg (DK); Frank Frederiksen, Klarup (DK)

(72) Inventors: Klaus Ingemann Pedersen, Aalborg (DK); Frank Frederiksen, Klarup (DK)

(21) Appl. No.: 14/404,041

(22) PCT Filed: Jun. 5, 2012
(86) PCT No.: PCT/EP2012/060554

§ 371 Date: Nov. 26, 2014

(51) Int. Cl. H04W 72/12; H04W 88/08

(52) U.S. Cl. CPC H04W 72/1278; H04W 88/08
USPC 370/329

(57) ABSTRACT

A method including receiving information at a first access node, said information related to a preference of allocation of communication resources associated with a second access node; and wherein said information includes an indication of the priority of at least some of said communication resources to said second access node.

The present application relates to communication between nodes in a wireless communication system.

A communication system can be seen as a facility that enables communication sessions between two or more entities such as fixed or mobile communication devices, base stations, servers and/or other communication nodes. A communication system and compatible communicating entities typically operate in accordance with a given standard or specification which sets out what the various entities associated with the system are permitted to do and how that should be achieved. For example, the standards, specifications and related protocols can define the manner how communication devices can access the communication system and how various aspects of communication shall be implemented between communicating devices. A communication can be carried on wired or wireless carriers. In a wireless communication system at least a part of the communication between at least two stations occurs over a wireless link.

Examples of wireless systems include public land mobile networks (PLMN) such as cellular networks, satellite based communication systems and different wireless local networks, for example wireless local area networks (WLAN). A wireless system can be divided into cells, and hence these are often referred to as cellular systems. A cell is provided by a base station. Cells can have different shapes and sizes. A cell can also be divided into sectors. Regardless of the shape and size of the cell providing access for a user equipment, and whether the access is provided via a sector of a cell or a cell, such area can be called radio service area or access area. Neighbouring radio service areas typically overlap, and thus a communication in an area can listen to more than one base station.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station of an access network and/or another user equipment. The communication device may access a carrier provided by a station, for example a base station, and transmit and/or receive communications on the carrier.

An example of communication systems attempting to satisfy the increased demands for capacity is an architecture that is being standardized by the 3rd Generation Partnership Project (3GPP). This system is often referred to as the long-term evolution (LTE) of the Universal Mobile Telecommunications System (UMTS) radio-access technology. The LTE aims to achieve various improvements, for example reduced latency, higher user data rates, improved system capacity and coverage, reduced cost for the operator and so on. A further development of the LTE is often referred to as LTE-Advanced. The various development stages of the 3GPP LTE specifications are referred to as releases.

In LTE-Advanced the network nodes can be wide area network nodes such as a macro eNode B (eNB)

According to a first aspect there is provided a method comprising: receiving information at a first access node, said information related to a preference of allocation of communication resources associated with a second access node; and wherein said information comprises an indication of the priority of at least some of said communication resources to said second access node.

Preferably said method comprises using said received information for determining scheduling of communications by said first access node.

Preferably said information comprises an indication that said first access node must avoid using certain communication resources.

Preferably said information comprises an indication that said first access node should preferably avoid using certain communication resources.

Preferably said information comprises an indication that said first access node may use certain communication resources.

Preferably said information comprises an indication that certain communication resources are to be reserved for said second access node.

Preferably the method comprises sending a request for said second access node to modify the allocation of communication resources.

Preferably said communication resources are associated with a control channel.

Preferably said control channel comprises a physical downlink control channel.

Preferably said first access node and said second access node comprise base stations.

Preferably said method is comprised in a Long Term Evolution system.

According to a second aspect there is provided a method comprising: providing information to a first access node, said information related to a preference of allocation of communication resources associated with a second access node; and wherein said information comprises an indication of the priority of at least some of said communication resources to said second access node.

Preferably said method comprises providing said information in a manner such that it can be used by said first access node for determining scheduling of communications by said first access node.

Preferably said information comprises an indication that said first access node must avoid using certain communication resources.

Preferably said information comprises an indication that said first access node should preferably avoid using certain communication resources.

Preferably said information comprises an indication that said first access node may use certain communication resources.

Preferably said information comprises an indication that certain communication resources are to be reserved for said second access node.

Preferably said method comprises receiving a request for said second access node to modify the allocation of communication resources.

Preferably said communication resources are associated with a control channel.

Preferably said control channel comprises a physical downlink control channel.

Preferably said first access node and said second access node comprise base stations.

Preferably said method is comprised in a Long Term Evolution system.

According to a third aspect there is provided an apparatus comprising: at least one processor and at least one memory including computer program code; the at least one memory and the computer program code configured to, with the at least one processor, cause at least a first access node to receive information, said information related to a preference of allocation of communication resources associated with a second access node; and wherein said information comprises an indication of the priority of at least some of said communication resources to said second access node.

Preferably said apparatus is configured to use said received information for determining scheduling of communications by said first access node.

Preferably said information comprises an indication that said first access node must avoid using certain communication resources.

Preferably said information comprises an indication that said first access node should preferably avoid using certain communication resources.

Preferably said information comprises an indication that said first access node may use certain communication resources.

Preferably said information comprises an indication that certain communication resources are to be reserved for said second access node.

Preferably the apparatus is configured to send a request for said second access node to modify the allocation of communication resources.

Preferably said communication resources are associated with a control channel.

Preferably said control channel comprises a physical downlink control channel.

Preferably said first access node and said second access node comprise base stations.

Preferably said apparatus is comprised in a Long Term Evolution system.

According to a fourth aspect there is provided an apparatus comprising:

at least one processor and at least one memory including computer program code;
the at least one memory and the computer program code configured to, with the at least one processor, cause at least a second access node to provide information to a first access node, said information related to a preference of allocation of communication resources associated with said second access node; and wherein said information comprises an indication of the priority of at least some of said communication resources to said second access node.

Preferably said apparatus is configured to provide said information in a manner such that it can be used by said first access node for determining scheduling of communications by said first access node.

Preferably said information comprises an indication that said first access node must avoid using certain communication resources.

Preferably said information comprises an indication that said first access node should preferably avoid using certain communication resources.

Preferably said information comprises an indication that said first access node may use certain communication resources.

Preferably said information comprises an indication that certain communication resources are to be reserved for said second access node.

Preferably the apparatus is configured to receive a request for said second access node to modify the allocation of communication resources.

Preferably said communication resources are associated with a control channel.

Preferably said control channel comprises a physical downlink control channel.

Preferably said first access node and said second access node comprise base stations.

Preferably said apparatus is comprised in a Long Term Evolution system.

According to a fifth aspect there is provide an apparatus comprising means for receiving information, said information related to a preference of allocation of communication resources associated with a second access node; and wherein said information comprises an indication of the priority of at least some of said communication resources to said second access node.

Preferably said apparatus comprises means for using said received information for determining scheduling of communications by said first access node.

Preferably said information comprises an indication that said first access node must avoid using certain communication resources.

Preferably said information comprises an indication that said first access node should preferably avoid using certain communication resources.

Preferably said information comprises an indication that said first access node may use certain communication resources.

Preferably said information comprises an indication that certain communication resources are to be reserved for said second access node.

Preferably the apparatus comprises means for sending a request for said second access node to modify the allocation of communication resources.

Preferably said communication resources are associated with a control channel.

Preferably said control channel comprises a physical downlink control channel.

Preferably said first access node and said second access node comprise base stations.

Preferably said apparatus is comprised in a Long Term Evolution system.

According to a sixth aspect there is provided an apparatus comprising means for providing information to a first access node, said information related to a preference of allocation of communication resources associated with a second access node; and wherein said information comprises an indication of the priority of at least some of said communication resources to said second access node.

Preferably said apparatus comprises means for providing said information in a manner such that it can be used by said first access node for determining scheduling of communications by said first access node.

Preferably said information comprises an indication that said first access node must avoid using certain communication resources.

Preferably said information comprises an indication that said first access node should preferably avoid using certain communication resources.

Preferably said information comprises an indication that said first access node may use certain communication resources.

Preferably said information comprises an indication that certain communication resources are to be reserved for said second access node.

Preferably said apparatus comprises means for receiving a request for said second access node to modify the allocation of communication resources.

Preferably said communication resources are associated with a control channel.

Preferably said control channel comprises a physical downlink control channel.

Preferably said first access node and said second access node comprise base stations.

Preferably said apparatus is comprised in a Long Term Evolution system.

According to a seventh aspect there is provided a computer program comprising computer executable instructions which when run on one or more processors perform the method as described herein.

Embodiments will now be described, by way of example only, with reference to the accompanying drawings in which:

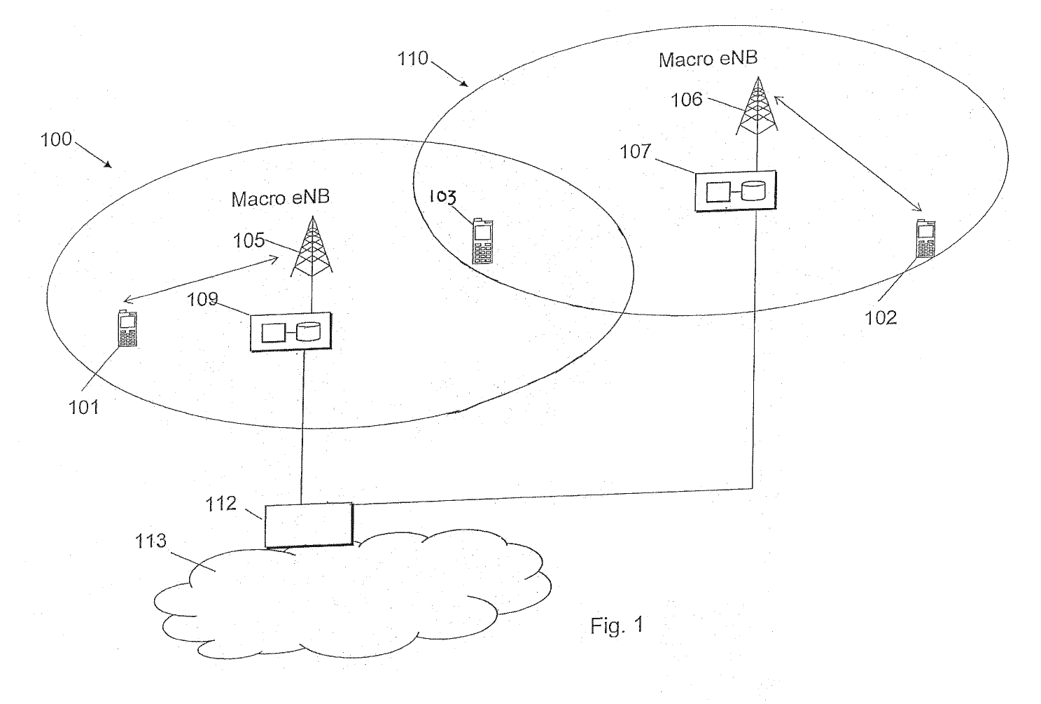

FIG. 1 shows a schematic diagram of a network according to some embodiments;

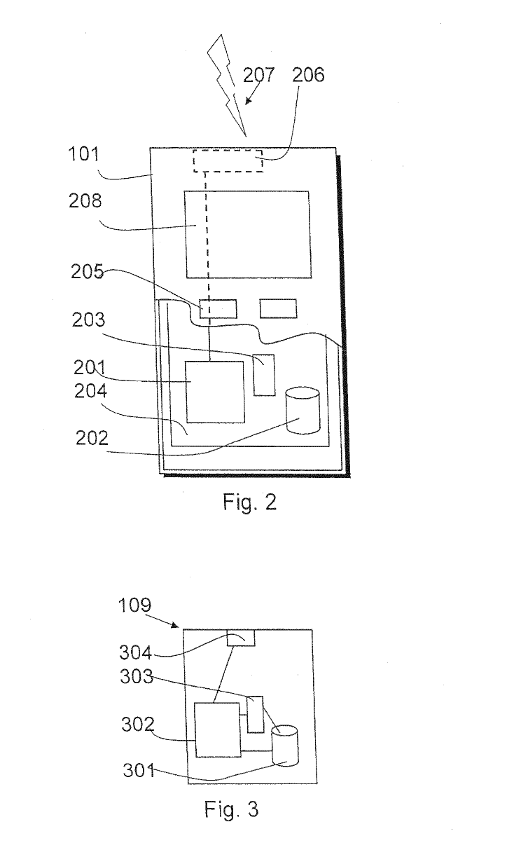

FIG. 2 shows a schematic diagram of a mobile communication device according to some embodiments;

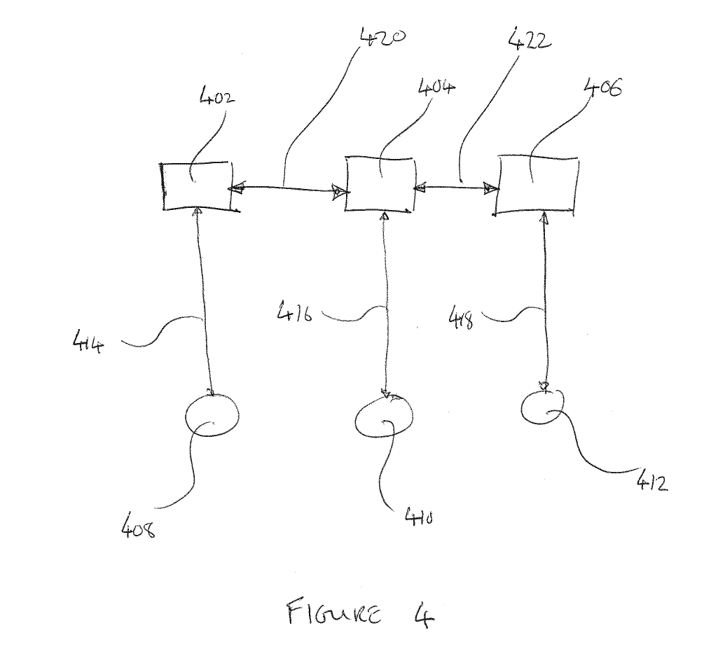

FIG. 3 shows a schematic diagram of a control apparatus according to some embodiments;

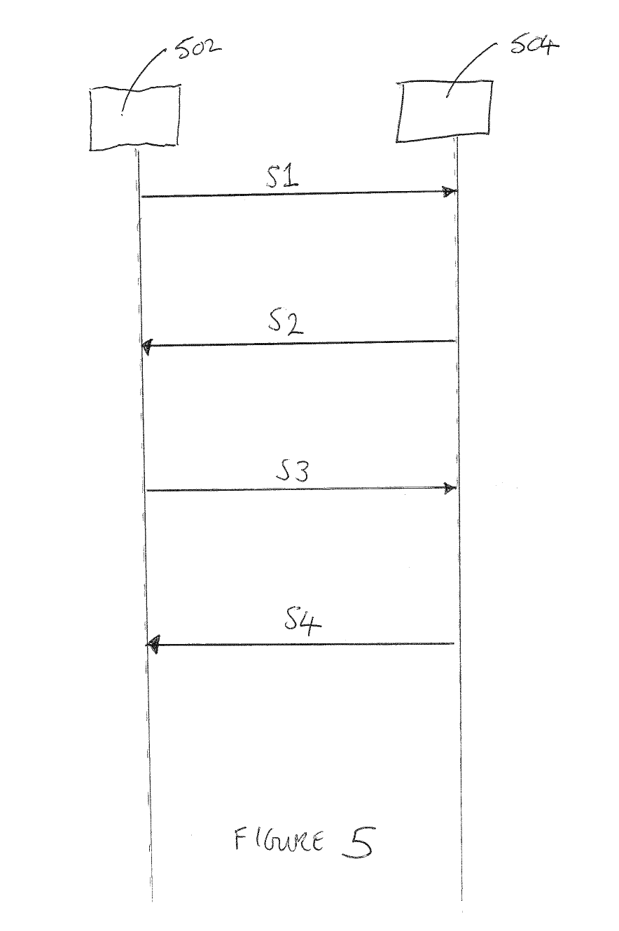

FIG. 4 is an example of a system in which some embodiments may be employed;

FIG. 5 shows signalling between two base stations according to some embodiments.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A communication device or user equipment 101, 102, 103, is typically provided wireless access via at least one base station or similar wireless transmitter and/or receiver node of an access system. In FIG. 1 two neighbouring and overlapping access systems or radio service areas 100, 110 are shown being provided by base stations 105, 106.

However, it is noted that instead of two access systems, any number of access systems can be provided in a communication system. An access system can be provided by a cell of a cellular system or another system enabling a communication device to access a communication system. A base station site 105, 106 can provide one or more cells. A base station can also provide a plurality of sectors, for example three radio sectors, each sector providing a cell or a subarea of a cell.

All sectors within a cell can be served by the same base station. A radio link within a sector can be identified by a single logical identification belonging to that sector. Thus a base station can provide one or more radio service areas. Each communication device 101, 102, 103, and base station 105, 106 may have one or more radio channels open at the same time and may send signals to and/or receive signals from more than one source.

Base stations 105, 106, are typically controlled by at least one appropriate controller apparatus 109, 107 so as to enable operation thereof and management of mobile communication devices 101, 102, 103, in communication with the base stations 105, 106, 108. The control apparatus 107, 109 can be interconnected with other control entities. The control apparatus 107, 109 can typically be provided with memory capacity 301 and at least one data processor 302. The control apparatus 107, 109 and functions may be distributed between a plurality of control units. In some embodiments, each base station 105, 106 can comprise a control apparatus 109, 107. In alternative embodiments, two or more base stations may share a control apparatus. Currently LTE does not have a separate radio network controller. In some embodiments the control apparatus may be respectively provided in each base station.

The cell borders or edges are schematically shown for illustration purposes only in FIG. 1. It shall be understood that the sizes and shapes of the cells or other radio service areas may vary considerably from the similarly sized omni-directional shapes of FIG. 1. The shapes of the cells could also vary as a function of the base station transmit power as well as the changing propagation conditions. In some embodiments, during network planning a cell coverage area is assumed to be static.

In particular, FIG. 1 depicts two wide area base stations 105, 106, which can be macro-eNBs 105, 106. The macro-eNBs 105, 106 transmit and receive data over the entire coverage of the cells 100 and 110 respectively. Alternatively, in LTE-Advanced, network nodes can be small area network nodes such as Home eNBs (HeNB) (femto cells) or pico eNodeBs (pico-eNB). HeNBs may be configured to support local offload and may support any UE or UEs belonging to a closed subscriber group (CSG) or an open subscriber group (OSG). In some instances a combination of wide area network nodes and small area network nodes can be deployed using the same frequency carriers (e.g. co-channel deployment). The coverage of the smaller area base station is generally smaller than the coverage of the wide area base stations 105, 106. The coverage provided by smaller area nodes (pico or femto nodes) may overlap with the coverage provided by the macro-eNBs. Pico eNBs can be used to extend coverage of the macro-eNBs outside the original cell coverage of the macro-eNBs. The pico eNB can also be used to provide cell coverage in “gaps” or “shadows” where there is no coverage within the existing cells and/or may serve “hot spots”. In some embodiments, the smaller area node can be a femto or Home eNB which can provide coverage for a relatively small area such as the home. Some environments may have both pico and femto cells.

As shown, the radio service areas can overlap. Thus signals transmitted in an area can interfere with communications in another area.

The communication devices 101, 102, 103, can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

Some non-limiting examples of the recent developments in communication systems are the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of appropriate access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

In FIG. 1 the base stations 105, 106, of the access systems can be connected to a wider communications network 113. The controller apparatus 107, 109 may be provided for coordinating the operation of the access systems. A gateway function 112 may also be provided to connect to another network via the network 113. The smaller base station 108 can also be connected to the other network by a separate gateway function 111. The base stations 105, 106, can be connected to each other by a communication link for sending and receiving data. The communication link can be any suitable means for sending and receiving data between the base stations 105, 106 and in some embodiments the communication link is an X2 link.

The other network may be any appropriate network. A wider communication system may thus be provided by one or more interconnect networks and the elements thereof, and one or more gateways may be provided for interconnecting various networks.

The communication devices will now be described in more detail with reference to FIG. 2. FIG. 2 shows a schematic, partially sectioned view of a communication device 101 that a user can use for communication. Such a communication device is often referred to as user equipment (UE) or terminal. An appropriate communication device may be provided by any device capable of sending and receiving radio signals. The communication device may be mobile. Non-limiting examples of a communication device include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The communication device 101 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204.

The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus 109 (or 107) for a communication system, for example to be coupled to, included in and/or for controlling a station of an access system. In some embodiments the base stations 105, 106, each comprise a control apparatus such as shown in FIG. 3. The control apparatus 109 can be arranged to provide control of communications by communication devices that are in the service area of the system. The control apparatus 109 can be configured to provide control functions in association with generation and communication of transmission patterns and other related information and for muting signals by means of the data processing facility in accordance with certain embodiments described below. For this purpose the control apparatus 109 comprises at least one memory 301, at least one data processing unit 302, 303 and an input/output interface 304. Via the interface the control apparatus can be coupled to a receiver and a transmitter of the base station. The control apparatus 109 can be configured to execute an appropriate software code to provide the control functions.

The LTE Rel-8 specifications include frequency domain inter-cell interference coordination (ICIC) for the downlink data channel. For example the X2 signalling protocol includes inter-eNB signalling of Relative Narrowband Transmit Power (RNTP) per physical resource block (PRB). The RNTP may be used by an eNB to announce planned transmissions per PRB in the future for data channel transmission. A neighbouring eNB can take such announcements in to account for protecting DL data transmissions in its own cell. A neighbouring eNB will typically only schedule data transmissions with robust modulation and coding schemes on those resources for which the announcement indicates a high interference level, or will not schedule cell-edge users on resources with high interference levels.

For LTE Rel-8/9/10 the physical downlink control channel (PDCCH) is transmitted from the eNB in the first few symbols of each subframe, if users are being scheduled. In the frequency domain the PDCCH is transmitted over the full carrier bandwidth i.e. mapped to UEs scattered over the full carrier bandwidth. Accordingly there may be no support for ICIC of the PDCCH.

A recent aspect of LTE is the enhanced PDCCH (ePDCCH) for the transmission of downlink control data in a set of pre-defined or pre-configured physical resources in the frequency domain. This may contrast with the transmission of users on the downlink data channel, where the assignment of the resources to be used may be defined in a dynamic way (decided for each transmission). The more static assignment of resources in the frequency domain for the ePDCCH may be configured in a way such that different resources are used at different time instants, but still, the exact location may be pre-configured and agreed between transmission (eNB) and reception (UE) nodes in the system.

Further features of the ePDCCH may include:
each ePDCCH is transmitted over a sub-set of the carrier bandwidth i.e. over a group of physical resource block (PRB) pairs, and over all non-PDCCH symbols in the subframe
the ePDCCH may be configured through radio resource control (RRC)
a UE will be configured for a set of resources (PRB pairs) to monitor for the ePDCCH. The set of resources may be fully or partially overlapping for different UEs
the ePDCCH may rely on DM RS for detection

Allocation of frequency resources on ePDCCH may in particular ensure a reasonable control of assigned resources per UE or group of UEs, in contrast to resource allocation on PDCCH where random procedures spread the frequency resources of a single UE over the whole frequency range. There may be the possibility to confine ePDCCH resources for a single UE, for instance, to a single PRB pair. Such confining of resources for control data transmission per UE or group of UEs may be used for interference control on ePDCCH.

Some embodiments may be further understood by viewing FIG. 4. This figure shows three base stations 402, 404 and 406; and three UEs 408, 410 and 412.

Base station 402 is in communication with UE 408 on communication link 414. Base station 404 is in communication with UE 410 on communication link 416. Base station 406 is in communication with UE 412 on communication link 418. Base station 402 is in communication with base station 404 on communication link 420, and base station 404 is in communication with base station 406 on communication link 422.

It should be understood that this figure is simplified for the purposes of explanation. In practice there may be any number of base stations and user equipment. Furthermore each base station and UE can be in communication with one or more further base stations and/or UEs at the same time.

Each base station 402, 404 and 406 is shown connected to respective user equipment 408, 410 and 412 by the above described communication links. For example base station 402 is shown connected to UE 408 by communication link 414. It should be appreciated that this communication link may comprise a number of channels. These channels may comprise one or more data channels and one or more control channels.

One such control channel may be the enhanced physical downlink control channel (ePDCCH).

The ePDCCH may carry control information, such as the layer 1 control. The ePDCCH may be used to carry information from an eNB to a UE, and this information may be used by the UE to determine which actions to perform in terms of its connection(s) with one or more eNBs. For example the ePDCCH may be used to send information relating to control of the resource allocation. It may also be used to send information relating to the coding and modulation scheme to be used by the user equipment. The ePDCCH may also be used for sending transmit power control (TPC) commands to the UE. Hybrid automatic repeat request (HARQ) information may also be communicated between a base station and a UE using the ePDCCH. Furthermore multiple-input multiple-output (MIMO) precoding information can be transmitted using the ePDCCH.

Since, as shown in FIG. 4, there are multiple base stations communicating with multiple UEs there may exist a potential for interference between communications on the various links 414, 416 and 418. Any transmission errors on the ePDCCH, whether caused by interference or otherwise, may lead to lack of transmission control and a corresponding impact on system performance.

As shown in FIG. 4 the base stations 402, 404 and 406 may communicate with each other via links 420 and 422. Although not shown in FIG. 4 a link may also exist between base station 402 and 406 for communication therebetween. The links 420 and 422 may comprise an X2 interface. By signalling on this interface in some embodiments the base stations can communicate with each other to schedule transmissions on their respective links with UEs so as to minimise interference.

FIG. 5 is an example of signalling between two base stations so as to, in this example, facilitate efficient ePDCCH inter cell interference coordination (ICIC). For ease of understanding communication between two base stations 502 and 504 is described. However it should of cause be appreciated that signalling may occur between any number of base stations.

At step S1 the base station 502 informs base station 504 which frequency domain resources base station 502 will use in each cell for ePDCCH transmission. Along with this information the base station 502 may also send further information relating to an importance or priority of certain communication resources to the base station 502. This information may be enumerated with a value to indicate the importance of certain communication resources to the base station 502. Using this information the neighbouring base station 504 can be given an indication whether to avoid use of those resources.

By way example only, the signalling from the base station 502 to the base station of 504 may be enumerated as “red”, “yellow” or “green”. These enumerations may have the following meaning:

“Red”—any ePDCCH transmission resources labelled as “red” may be considered critical or vital resources. This means that neighbouring cells should preferably avoid using these transmission resources since very little interference can be tolerated for those resources.

“Yellow”—any ePDCCH transmission resources labelled as “yellow” are less critical resources. This means that neighbouring cells may use the resources. However, if the neighbouring cell can serve its users without using “yellow” resources, then this is recommended.

“Green”—any ePDCCH transmission resources labelled as “green” may not be considered critical resources. Neighbouring cells may therefore use these “green” resources at all times without causing ePDCCH interference problem at neighbouring base stations.

It should of course be appreciated that the use of values “red”, “yellow” and “green” are for the purposes of explanation only and any way of signalling this information to neighbouring base stations is envisaged, the purpose being that one base station has the ability to indicate a preference to neighbouring base stations for how external interference should be created. Furthermore, the number of categories of values that are used in some embodiments is not limited to three (“red”, “yellow”, “green”). In some embodiments any number from two or more categories are envisaged.

Different preference levels may in particular be used for distinguishing between resources on ePDCCH for cell-edge UEs and resources on ePDCCH for cell-centre UEs. Control data to cell-edge UEs may preferably be transmitted using the highly protected “red” resources on ePDCCH while the less protected “yellow” resources on ePDCCH may be used for transmitting control data to cell-centre UE. This near/far interference preference scheduling may even be used when the same search space is configured for all UEs on ePDCCH.

In the examples given thus far, a first base station signals to a second base station that the second base station should or should not use certain resources. This may be considered a form of explicit instruction. In other embodiments the first base station may inform the second base station which resources the first base station is using, and from that information the second base station may determine which resources it can use. This may be considered a form of implicit instruction.

It will of course be appreciated that the apparatus or base station which receives the information also comprises the means to implement scheduling according to the received instruction. That is if the base station receives any of the above “red”, “yellow” or “green” instructions, then it may also comprise the means to put the instruction into effect.

At step S2 the base station 504 may send a request to base station 502 to modify its assigned resource allocation for the ePDCCH. This may occur for example if base station 504 has received, in step S1, information that use of a certain PRB set should be avoided for the ePDCCH. If base station 504 cannot avoid using this PRB set without a detrimental effect on system performance then it may send the message in step S2 to base station 502 for a modified resource allocation.

At step S3 the base station 502 may transmit an updated message to the base station 504, informing base station 504 of an updated set of communication resources base station 502 will use.

If the base station 504 can implement use of communication resources in accordance with this updated message, then at step S4 it may send an acknowledgment message to the base station 502 to confirm that the resource allocation is being applied.

It should be appreciated that if following step S1 the base station 504 is capable of utilising communication resources in accordance with instructions from base station 502, then it may immediately send an acknowledgment message back to the base station 502. In this scenario steps S2 and S3 are unnecessary.

Thus according to some embodiments a base station can pre-empt an interference situation. In other words some embodiments enable a base station to “push” instructions to neighbouring base stations so as to introduce an optimal interference pattern in the frequency domain. This may enable an eNB to take an active role in introducing an optimal interference pattern for that eNB.

Some embodiments also provide a feedback mechanism which enables neighbouring eNBs to negotiate ePDCCH resources. Such negotiations may be beneficial for improving the interference coordination when the resources in the frequency domain for ePDCCH may be configured in a generally static way.

Some embodiments may also be able to distinguish between cell-edge UEs and cell-centre UEs. For example in some embodiments resources may be more highly protected for cell-edge users than for cell-centre users. In embodiments this distinction may be made by the eNB scheduler.

Thus some embodiments may provide a frequency-domain inter-cell interference coordination scheme for ePDCCH.

It should be appreciated that the above description is by way of example only, and that certain modifications are possible. For example the signalling mechanism has been discussed in the context of inter-cell coordination for the ePDCCH. This principle could however also be utilised for data channels and/or for other control channels.

Where the term “base station” has been used in the description this is considered to cover node Bs and enhanced node Bs (eNBs) also.

Certain terms within the description have related to the LTE standard. However it should be appreciated that the principles and concepts set forth may also be applicable to other standards and/or other versions of the LTE standard.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory.

Although the application has been described herein above with reference to specific embodiments, it is not limited to these embodiments and no doubt further alternatives will occur to the skilled person, that lie within the scope of the invention as claimed.

1. A method comprising:
receiving information at a first access node, said information related to a preference of allocation of communication resources associated with a second access node and wherein said information comprises an indication of the priority of at least some of said communication resources to said second access node.

2. A method as set forth in claim 1, comprising using said received information for determining scheduling of communications by said first access node.

3. A method as set forth in claim 1, wherein said information comprises an indication that said first access node must avoid using certain communication resources

4. A method as set forth in claim 1, wherein said information comprises an indication that said first access node should preferably avoid using certain communication resources.

5. A method as set forth in claim 1, wherein said information comprises an indication that said first access node may use certain communication resources.

6. A method as set forth in claim 1, wherein said information comprises an indication that certain communication resources are to be reserved for said second access node.

7. A method as set forth in claim 1, comprising sending a request for said second access node to modify the allocation of communication resources.

8. A method as set forth in claim 1, wherein said communication resources are associated with a control channel.

9. A method as set forth in claim 1, wherein said control channel comprises a physical downlink control channel.

10. A method as set forth in claim 1, wherein said first access node and said second access node comprise base stations.

11. A method as set forth in claim 1, comprised in a Long Term Evolution system.

12. A method comprising:
providing information to a first access node, said information related to a preference of allocation of communication resources associated with a second access node and wherein said information comprises an indication of the priority of at least some of said communication resources to said second access node.

13-22. (canceled)

23. An apparatus comprising:
at least one processor
and at least one memory including computer program code;
the at least one memory and the computer program code configured, with the at least one processor, to cause the apparatus to perform at least the following:
receive information, said information related to a preference of allocation of communication resources associated with an access node; and
wherein said information comprises an indication of the priority of at least some of said communication resources to said access node.

24. An apparatus comprising:
at least one processor
and at least one memory including computer program code,
the at least one memory and the computer program code configured, with the at least one processor, to cause the apparatus to perform at least the following:
provide information to an access node, said information related to a preference of allocation of communication resources associated with the apparatus; and
wherein said information comprises an indication of the priority of at least some of said communication resources to the apparatus.

25. A computer program comprising a non-transitory computer-readable storage medium bearing computer program code embodied therein for use with a computer, the computer program code comprising code for performing the method of claim 1.
